(19) United States
(12) Patent Application Publication
(10) Pub. No.: US 2013/0229115 A1
(43) Pub. Date: Sep. 5, 2013

(54) Methods for Disaggregated Sensing of Artificial Light and Daylight Distribution

(71) Applicants: Ashish Vijay Pandharipande, Eindhoven (NL); David Caicedo Fernández, Endhoven (NL)

(72) Inventors: Ashish Vijay Pandharipande, Eindhoven (NL); David Caicedo Fernández, Endhoven (NL)

(21) Appl. No.: 13/884,012

(22) PCT Filed: Oct. 10, 2011
(86) PCT No.: PCT/IB2011/054448

§ 371 Date: May 8, 2013

(30) Foreign Application Priority Data
Nov. 11, 2010 (EP) 10190792.1

(51) Int. Cl. H05B 37/02

(52) U.S. Cl. CPC H05B 37/0218
USPC 315/152

(57) ABSTRACT

A method, configuration unit (100), and control unit (160) for configuring a lighting system (101) with respect to light other than light emitted from an illumination device (103) are provided. The lighting system comprises the at least one illumination device arranged in an illumination plane (104) to illuminate a workspace plane (110). The method comprises the step of obtaining a first contribution of the light other than the light emitted from the illumination device at a first location (113) in the illumination plane based on a first signal representative of a total light intensity measured at the first location. Furthermore, the method comprises the step of obtaining a second contribution of the light other than the light emitted from the illumination device at a second location (121) in the workspace plane based on a second signal representative of a total light intensity measured at the second location. Moreover, the method comprises the step of determining a transfer function (130) representative of the relationship between the first and the second contributions of the light other than the light emitted from the illumination device.

### FIELD OF THE INVENTION

The present invention relates to methods and apparatuses for disaggregated sensing of artificial light and daylight distribution. In particular, the present invention relates to a method of configuring a lighting system and a configuration unit thereof and a method of controlling a lighting system and a control unit thereof.

### BACKGROUND OF THE INVENTION

Artificial lighting is used for many indoor and outdoor applications, such as e.g. offices, restaurants, museums, advertising boards, homes, shops and shop windows. For many years, the control of artificial lighting has been manual. However, manual control of the lighting may be undesired, inefficient and/or tedious. In order to reduce the problem associated with manual control, lighting systems based on automatic control have been developed. An automatic control is particularly advantageous for lighting systems comprising a plurality of light sources and in which the light sources are placed at different locations in an interior space such as, e.g., a room, a building or a store. Any manual operation for switching on or off or regulating the power level of the light sources would be inconvenient.

Recently, automatic lighting systems have evolved not requiring any manual operation. Furthermore, automatic lighting systems have been developed to improve energy efficiency as compared to systems based on manual control. Automatic systems may e.g. comprise a number of sensors to improve the control of the lighting. Energy efficient automatic systems are of interest since, in e.g. some office buildings, lighting alone may constitute a large part of the total energy consumed, as high as approximately 25% to 35%. Automatic systems are in general preferred for economical and/or environmental reasons.

To save even more energy, it may be beneficial to use the contribution of daylight to illuminate the interior of a space such as a room, building or store. Indeed, during a bright day, daylight may provide a significant amount of light intensity into an interior space, especially if it is e.g. a space enclosed in a surface comprising large and/or many windows. Such daylight may be sufficient for normal lighting conditions without the need of artificial lighting. In contrast, during early mornings, evenings and/or nights, or even specific seasons of the year, daylight may not provide sufficient illumination. In this case, the lighting in the interior space may be reinforced by the use of artificial lighting. Furthermore, daylight in an interior space may be highly irregular in different areas of the space. For example, light intensity of daylight may be high close to a window whereas it is low in the “shadow” of a piece of furniture such as a book shelf. Thus, control of artificial lighting is advantageously performed with respect to daylight.

However, existing prior art systems for determining daylight distributions are often prohibitively expensive and/or complex. Thus, there is a need for providing new methods and devices for determining daylight contribution and new methods and devices for controlling lighting with respect to daylight.

### SUMMARY OF THE INVENTION

It is an object of the present invention to mitigate the above problems and to provide improved methods and devices for, on the one hand, determining the contribution of any light other than light emitted from illumination device(s) of a lighting system (e.g. daylight contribution) and, on the other hand, controlling lighting of a lighting system with respect to such an external light contribution.

This and other objects are achieved by providing a method of configuring, a configuration unit, a method of controlling and a control unit having the features defined in the independent claims. Preferred embodiments are defined in the dependent claims.

Hence, according to a first aspect of the present invention, there is provided a method of configuring a lighting system with respect to light other than light emitted from at least one illumination device. The lighting system comprises the at least one illumination device arranged in an illumination plane to illuminate a workspace plane. The method comprises the step of obtaining a first contribution of the light other than light emitted from the at least one illumination device at a first location in the illumination plane based on a first signal representative of a total light intensity measured at the first location. Furthermore, the method comprises the step of obtaining a second contribution of the light other than light emitted from the at least one illumination device at a second location in the workspace plane based on a second signal representative of a total light intensity measured at the second location. The method then comprises the step of determining a transfer function representative of the relationship between the first and the second contributions of the light other than light emitted from the at least one illumination device.

According to a second aspect of the present invention, there is provided a configuration unit for configuring a lighting system with respect to light other than light emitted from at least one illumination device. As for the first aspect of the present invention, the lighting system comprises the at least one illumination device arranged in an illumination plane to illuminate a workspace plane. The configuration unit is adapted to obtain a first contribution of the light other than light emitted from the at least one illumination device at a first location in the illumination plane based on a first signal representative of a total light intensity measured at the first location. The configuration unit is further adapted to obtain a second contribution of the light other than light emitted from the at least one illumination device at a second location in the workspace plane based on a second signal representative of a total light intensity measured at the second location. The configuration unit is then adapted to determine a transfer function representative of the relationship between the first and the second contributions of the light other than light emitted from the at least one illumination device.

According to a third aspect of the present invention, there is provided a method of controlling lighting in a lighting system. The lighting system comprises at least one illumination device arranged in an illumination plane to illuminate a workspace plane. The method comprises the step of receiving a transfer function representative of the relationship between the contribution of light other than light emitted from the at least one illumination device in the illumination plane and the contribution of the light other than light emitted from the at least one illumination device in the workspace plane. The method further comprises the step of obtaining a signal representative of a total light intensity measured at a location in the illumination plane and the step of determining the contribution of the light other than light emitted from the at least one illumination device in the obtained signal. Moreover, the method comprises the step of controlling the illumination device based on the determined contribution, in the illumination plane, of the light other than light emitted from the at least one illumination device and the transfer function.

According to a fourth aspect of the present invention, there is provided a control unit for controlling lighting (or a lighting function) in a lighting system. The lighting system comprises at least one illumination device arranged in an illumination plane to illuminate a workspace plane. The control unit is adapted to receive a transfer function representative of the relationship between the contribution of light other than light emitted from the at least one illumination device in the illumination plane and the contribution of the light other than light emitted from the at least one illumination device in the workspace plane. The control unit is further adapted to obtain a signal representative of a total light intensity measured at a location in the illumination plane and to determine the contribution of the light other than light emitted from the at least one illumination device in the obtained signal. Furthermore, the control unit is adapted to control the illumination device based on the determined contribution, in the illumination plane, of the light other than light emitted from the at least one illumination device and the transfer function.

According to even a further aspect of the present invention, there is provided a computer program product, loadable into a configuration unit or control unit of a lighting system, comprising software code portions for causing a processing means of the configuration unit to perform the steps of the method according to the first aspect of the present invention.

According to even a further aspect of the present invention, there is provided a computer program product, loadable into a control unit of a lighting system, comprising software code portions for causing a processing means of the control unit to perform the steps of the method according to the third aspect of the present invention.

Thus, the present invention is based on the idea of first configuring a lighting system with respect to light other than light emitted from illumination device(s) of the lighting system (e.g. daylight) by determining a transfer function between a first contribution of the light other than light emitted from the illumination device(s) of the lighting system (e.g. daylight illumination) obtained in the illumination plane (based on a total light intensity measured in the illumination plane) and a second contribution of the light other than light emitted from the illumination device(s) of the lighting system (e.g. daylight illumination) obtained in the workspace plane (based on a total light intensity measured in the workspace plane). The transfer function is representative of the relationship between the obtained first and second contributions of the light other than light emitted from the illumination device(s) of the lighting system. Thus, a configuration process is first provided wherein a transfer function or correlation between the contribution, in an illumination plane, of the light other than light emitted from the illumination device(s) of the lighting system and the contribution, in a workspace plane, of the light other than light emitted from the illumination device(s) of the lighting system is established. The present invention is advantageous in that, with the determined transfer function, a contribution of the light other than light emitted from the illumination device(s) of the lighting system (e.g. daylight illumination) in the workspace plane may be estimated or derived from a contribution of the light other than light emitted from the illumination device(s) of the lighting system (e.g. daylight illumination) obtained in the illumination plane without the need of direct measurements in the workspace plane.

In the present application, it will be appreciated that expressions like “light other than light emitted from the illumination device(s) of the lighting system” or “light other than light emitted from the at least illumination device” may include daylight, such as sunlight, which may predominantly radiate into an interior space (such as a room) via e.g. a window, or any artificial lighting such as e.g. street lighting or corridor lighting. For indoor applications in particular, light other than light emitted from the illumination device(s) of the lighting system may be any light emitted from light sources external to the lighting system, i.e. light sources arranged outside the interior space in which the lighting system is arranged (such as e.g. light from a corridor or from a neighboring interior space) but also any light sources being arranged in the interior space but not being part of the lighting system (such as e.g. an emergency exit sign).

Normally, the main contribution to such “light other than light emitted from the at least one illumination device” is from sunshine (i.e. daylight) and thus, in the following, reference will mainly be made to daylight. It will therefore be appreciated that the term “daylight” or “daylight illumination” in the following is interchangeable with expressions like “(any) light other than light emitted from the at least one illumination device”.

In other words, during a configuration session or process, the method of configuring and the configuration method of the present invention determine a transfer function by which, at a later stage (e.g. during control of the lighting system), a contribution of daylight illumination in the workspace plane may be determined from a contribution of daylight illumination obtained in the illumination plane. By means of the transfer function, the contribution of daylight illumination in the workspace plane may be estimated without the need of performing further daylight illumination measurements in the workspace plane.

It will be appreciated that the inventors have realized that a method of configuring and a configuration unit may be provided to configure a lighting system with respect to daylight illumination during a configuration session or process (i.e. in advance). As a result, the lighting system is prepared for the need of forthcoming determinations of daylight illumination in the workspace plane, e.g. if required for control of the lighting. The present invention is advantageous in that it provides a configuration of the lighting system with respect to daylight, wherein the distribution of daylight may be dynamically changing. The transfer function determined during the configuration provides for a determination of daylight illumination in the workspace plane during control of the lighting system without the need of direct measurements of daylight in the workspace plane but, instead, via measurements in the illumination plane, which is more convenient. In contrast, prior art systems for determining daylight distributions are often expensive and/or complex using e.g. goniophotometers or cameras. The configuration unit and the configuring method of the present invention are therefore advantageous in that they efficiently and conveniently prepare the lighting system for an efficient and convenient determination of a contribution of daylight illumination in the workspace plane.

The lighting system comprises (an) illumination device(s) arranged in an illumination plane to illuminate a workspace plane. The illumination device(s) may be arranged in a ceiling and/or wall of a room, or in a plane parallel to a ceiling and/or wall, whereas the workspace plane is a plane facing the illumination plane (which may e.g. be substantially parallel to the illumination plane).

The workspace plane may e.g. be the floor of an interior space or a plane defined to be substantially parallel to the floor and located at a certain distance from the floor. Alternatively, the workspace plane may be defined to be substantially parallel to the ceiling of an interior space and located at a certain distance from the ceiling. It will be appreciated that the workspace plane and the illumination plane do not necessarily need to be parallel to each other.

The configuring method and configuration unit obtain a first contribution of daylight illumination at a first location in the illumination plane based on a first signal representative of a total light intensity measured at the first location. The first location may be a point in the illumination plane at which a photosensor is arranged, e.g. in a close vicinity of (or near) one or more illumination devices.

Furthermore, the configuring method and configuration unit obtain a second contribution of daylight illumination at a second location in the workspace plane based on a second signal representative of a total light intensity measured at the second location. The second location may be a point anywhere in the workspace plane. For the purpose of the measurement of light illumination, a photosensor may be (at least temporarily) arranged at the second location.

Moreover, the configuring method and configuration unit provide a transfer function representative of the relationship between the first and the second contributions of daylight illumination. The transfer function may here be construed as a function (such as a mathematical function or operative matrix) which may transfer, correlate, or “map”, a contribution of daylight illumination from the illumination plane to the workspace plane. The transfer function may be dependent on a plurality of parameters such that a mapping from the illumination plane to the workspace plane fulfils demands on reliability, accuracy and/or repeatability. For example, the transfer function may be time and/or space dependent, i.e. transferring lighting in the illumination plane to the workspace plane dependent on the time of day and/or the area of e.g. a room.

With respect to the controlling method and control unit, it will be appreciated that the computation of both the received transfer function and the obtained signal may lead to the contribution of daylight in the workspace plane, thereby enabling control of the illumination device(s). In other words, the illumination device can be controlled based on the determined contribution of daylight illumination in the illumination plane and the transfer function. As mentioned above, this is advantageous in that it only requires a determination of the contribution of daylight illumination in the illumination plane without the need of measuring the contribution of daylight illumination in the workspace plane. The control of the lighting system is thus performed, by means of the transfer function, such that an estimation of daylight illumination in the workspace plane is obtained from measurements made only in the illumination plane. For this purpose, a plurality of photosensors may be provided in the illumination plane.

The present invention is this particularly advantageous in that it alleviates problems related to measurements in a workspace plane during control of the illumination devices. Instead of a direct measurement, the present invention is based on an estimation via the transfer function, which is advantageous in that it is more convenient and less obstructive.

The present invention is also advantageous in that the lighting may be controlled with respect to dynamical changes in that the contribution of daylight in the workspace plane will directly be determined from the contribution of daylight obtained in the illumination plane. In particular, the transfer function may be dependent on the various possible conditions of daylight illumination.

The present invention is also advantageous in that it provides a reliable estimation of the contribution of daylight in the workspace plane.

In the following, embodiments relating in particular to the first and second aspects of the present invention will be described. However, since the various aspects of the present invention may, in some embodiments, be combined, these embodiments may in principle apply to any one of the above mentioned aspects. In particular, it will be appreciated that all embodiments described with reference to the method of configuring a lighting system according to the first aspect may directly apply to the configuration unit according to the second aspect. Similarly, all embodiments described with respect to the method of controlling the lighting system according to the third aspect may directly apply to the control unit according to the fourth aspect.

According to an embodiment of the present invention, the illumination device may be turned off. In the present embodiment, wherein the illumination device(s) may be inactive, the first and the second contributions of daylight illumination will be equal to the total light intensities measured at the first and the second locations, respectively. An advantage with the present embodiment is that the configuration of the lighting system becomes even more efficient, as any contribution from illumination device(s) need not be taken into account in the configuration. There is a direct correlation between the measured light intensities and the contributions of daylight in the respective planes. For this purpose, the configuration unit may be further adapted to detect or receive information about detection whether the illumination device(s) are turned off. If they are turned off, then the configuration unit may initiate a configuration session in accordance with the above mentioned procedure.

According to an embodiment of the present invention, the configuring method may further comprise the step of estimating any first potential contribution of illumination by the illumination device in the first signal for obtaining the first contribution of daylight illumination, and estimating any second potential contribution of illumination by the illumination device in the second signal for obtaining the second contribution of daylight illumination. An advantage with the present embodiment is that the configuration of the lighting system may be performed even if the illumination device(s) is/are turned on. With the present embodiment, the configuration of the lighting system may be adapted to the contribution of light emanating from any illumination device(s) in the first and the second signals. The present embodiment is advantageous in that a more reliable determination of the transfer function is obtained in that the configuration is dependent on the light contribution from active illumination device(s).

According to an embodiment of the present invention, the configuring method may further comprise the step of determining a transfer function representative of the relationship between the estimated first potential contribution and the estimated second potential contribution. The present embodiment is advantageous in that it provides a configuration of artificial lighting in a workspace plane with respect to the contribution of artificial lighting in an illumination plane. Hence, with the present embodiment, by estimating the contribution of illumination devices in an illumination plane, a contribution of these devices to illumination in the workspace plane may be derived from the transfer function without the need of any direct measurement of light intensities in the workspace plane. A further advantage with the present embodiment is that the lighting system may be configured for predicting the effect of the contribution of the illumination devices to illumination in the workspace plane, thereby providing a more accurate control of the illumination devices at a later stage (during control).

According to an embodiment of the present invention, the step of obtaining a first contribution of daylight illumination may be repeated for a plurality of first locations in the illumination plane or for a plurality of time points and the step of obtaining a second contribution of daylight illumination may be repeated for a plurality of second locations in the workspace plane or for a plurality of time points. An advantage with the present embodiment is that the determination of the transfer function representative of the relationship between the first and the second contributions of daylight illumination is further improved and, in particular, more accurate since the contributions of daylight illumination are obtained for an increased number of first and second locations and/or an increased number of time points.

It will be appreciated that the repeated measurements for obtaining the contributions of daylight illumination at the first and second locations may vary in space and/or in time. For example, the measurements may be performed for a plurality of first and second locations for covering several locations of an interior space, and/or for a plurality of time instants during e.g. a morning, afternoon, evening, and/or night for covering various types of illumination conditions via daylight. As a result, an improved transfer function may be obtained, dependent on space and/or time, resulting in an improved configuration of the lighting system and later, an improved control of the lighting in the lighting system. Such an improved transfer function is advantageous in that the control of the lighting is more accurate for various conditions of daylight illumination.

According to an embodiment of the present invention, the step of estimating any first potential contribution may be repeated for a plurality of first locations in the illumination plane or for a plurality of power levels, and the step of estimating any second potential contribution may be repeated for a plurality of second locations in the workspace plane or for a plurality of power levels. An advantage with the present embodiment is that the determination of transfer function representative of the relationship between the first and the second potential contributions is further improved and, in particular, more accurate since the potential contributions are obtained for an increased number of first and second locations and/or an increased number of power levels. The repeated measurements for obtaining the potential contributions at the first and second locations may vary in space, time and/or power levels (dimming) of the illumination devices. The dimming may be varied as a function of space and/or time if a plurality of illumination devices is arranged in the illumination plane.

According to an embodiment of the present invention, the first contribution of daylight illumination may be obtained by subtracting the estimated first potential contribution from the first signal, and the second contribution of daylight illumination may be obtained by subtracting the estimated second potential contribution from the second signal, which is an advantageous (and a relatively easy) manner of obtaining the first and the second contributions of daylight illumination.

According to an embodiment of the present invention, the step of estimating the first potential contribution and the second potential contribution is based on frequency division multiplexing. In this context, the frequency division multiplexing implies that the first and the second potential contributions may be estimated by identifying illumination contributions from a single illumination device and/or a group of illumination devices via the frequency allocated to this specific single illumination device or group of illumination devices. An advantage with the present embodiment is that the identification of the contribution of a specific single illumination device and/or specific group of illumination devices is facilitated. Indeed, a contribution of all illumination devices to the total measured light intensity might be difficult to obtain. However, in general, using pulse width modulation (PWM) signals to control the illumination devices such as light emitting diodes (LEDs), the dc component of the signal representative of the total light intensity measured at a location may be attributed to the estimated daylight contribution while the harmonic components of the signal representative of the total light intensity measured at the location may be attributed to individual LED sources (where the frequency of the PWM signal translates to particular harmonics). Thus, the contribution of each of the light sources may first be determined based on a frequency analysis and a sum of the contributions of each of the light sources may be determined for the purpose of calculating, by subtraction, the contribution of daylight from the signal representative of the total intensity measured at a location.

In the following, embodiments of the present invention relating in particular to the control of the lighting, i.e. to the third and fourth aspects of the present invention, will be described.

According to an embodiment, the controlling method may further comprise the step of estimating any potential contribution of illumination by the illumination device(s) in the obtained signal and the contribution of daylight illumination may then be based on the estimated potential contribution. An advantage with the present embodiment is that the contribution of the illumination devices to the obtained signal (representative of the total light intensity) may be compensated for when determining the contribution of daylight in the obtained signal. Thus, a more accurate determination of the contribution of daylight is obtained, thereby resulting in a more accurate control of the lighting. As for the configuration session mentioned above, the light sources may be operated based on PWM signals thereby enabling identification of each of the signal sources or group of signals sources via the allocated frequency.

According to an embodiment of the present invention, the controlling method may further comprise the step of receiving an additional transfer function representative of the relationship between the contribution of illumination by the illumination device(s) in the illumination plane and the contribution of illumination by the at least one illumination device in the workspace plane, wherein the controlling of the at least one illumination device is further based on the additional transfer function. An advantage with the present embodiment is that the control of the lighting in a lighting system is even further improved, as the additional transfer function provides a control which is further based on a predicted contribution of illumination by the illumination device(s) in the workspace plane. In other words, the control of the lighting in the lighting system may take into account a predicted illumination level by the illumination device(s) in the workspace plane by means of the additional transfer function. For this purpose, the control unit may record the transfer function (or a set of values for contributions in the illumination plane and workspace plane) and from an estimated contribution of illumination in the obtained signal retrieve the corresponding parameters such a dimming (power level), location and/or time. The control unit may then be adapted to, with respect to a desired illumination level, retrieve the optimal parameter (in particular the power level) for controlling the illumination device.

According to an embodiment of the present invention, the controlling method may further comprise the step of receiving information relating to presence detection of a target in the workspace plane, wherein the controlling of the illumination device(s) is further based on whether a target is detected in the workspace plane. An advantage with the present embodiment is that the controlling of the illumination device may be adapted to the presence (or absence) of a target in the workspace plane. The controlling thereby provides a more energy-efficient illumination, as the illumination may be turned on or increased if a target is detected in the workspace plane, and analogously, be turned off or decreased if no target is detected in the workspace plane. By the term “target”, it is here meant an object which may move, such as a person walking in a room. For this purpose, the control unit may be operatively connected to a presence detection sensor adapted to detect the presence of a target. Such a presence detection sensor may be an ultrasound sensor or a radio-frequency sensor. Such a sensor may be arranged at a wall or ceiling of an interior space comprising the illumination plane and the workspace plane.

According to an embodiment of the present invention, the controlling method may further comprise the step of controlling the illumination device based on the position and/or the number of any targets detected in the workspace plane, which is advantageous in that the controlling of the illumination device is even further improved, in particular with respect to energy efficiency. The illumination device(s) may be controlled based on the position(s) of the target(s), such that e.g. more light may be provided in an area wherein the target is detected. Instead of increasing or decreasing the lighting for the whole interior space or workspace plane, a local lighting may be increased or decreased. Furthermore, the illumination device(s) may be controlled based on the number of targets detected in the workspace plane, thereby adapting the light with respect to the number of targets. For example, the lighting may be increased if there are a large number of persons in a room, due to e.g. shadows and/or obstructions of the lighting or the illumination devices themselves.

According to an embodiment of the present invention, the controlling method may further comprise the step of controlling the illumination device based on a predetermined illumination level or predetermined range of illumination levels in the workspace plane. Indeed, a predetermined illumination level or predetermined range of illumination levels in the workspace plane may be preferred or required with respect to e.g. standardization. The lighting may then be automatically controlled towards such a predetermined illumination level or predetermined range. The present embodiment is particularly advantageous in combination with the two preceding embodiments related to presence detection in that if a presence of a target is detected in the workspace plane, the lighting may be controlled to the preferred or required level of illumination. Similarly, if no target is detected, then the lighting is controlled to be at a lower level. An advantage with the present embodiment is therefore that the controlling provides an even more energy-efficient, preferred and/or convenient lighting. For example, the predetermined illumination level may be preset to a level which is relatively low in absence of target, thereby saving energy. Furthermore, different areas of e.g. a room may have different predetermined illumination levels or ranges, such that the lighting is adapted as a function of space. Moreover, the control of the illumination devices based on a predetermined illumination level or predetermined range may be dependent on time, i.e. that a low or high level of lighting is provided during certain periods of time.

According to an embodiment of the present invention, the controlling method may further comprise the step of obtaining the transfer function and/or the additional transfer function in accordance with any one of the embodiments described above with respect to configuration of the lighting system (i.e. the first and/or second aspect of the present invention). Advantages with the present embodiment may be any of the already mentioned advantages in connection to the configuration of the lighting system. For this purpose, it will be appreciated that the configuration unit and the control unit may be separate entities or a single entity.

It will be appreciated that the specific embodiments and any additional features described above with reference to the configuring method are likewise applicable and combinable with the configuration unit according to the second aspect of the present invention, the configuring method according to the third aspect of the present invention and the control unit according to the fourth aspect of the present invention.

Further objectives of, features of, and advantages with, the present invention will become apparent when studying the following detailed disclosure, the drawings and the appended claims. Those skilled in the art will realize that different features of the present invention can be combined to create embodiments other than those described in the following.

### BRIEF DESCRIPTION OF THE DRAWINGS

These and other aspects of the present invention will now be described in more detail, with reference to the appended drawings showing a currently preferred embodiment of the invention, wherein:

FIG. 1 is a schematic illustration of a configuration unit for configuring a lighting system in accordance with an embodiment of the present invention,

FIG. 2 is a diagram of a contribution of daylight illumination in a workspace plane in accordance with an embodiment of the present invention,

FIG. 3 is a diagram of a total light intensity measured in a workspace plane in accordance with embodiments of the present invention,

FIG. 4 is a diagram of dimming levels of illumination devices in accordance with an embodiment of the present invention,

FIG. 5 is a diagram of energy savings for different locations in accordance with an embodiment of the present invention, and

FIG. 6 is a view of a trajectory of a target obtained by a sensor in accordance with an embodiment of the present invention.

### DETAILED DESCRIPTION OF THE EMBODIMENTS

In the following description, the present invention is described with reference to a configuration unit for configuring a lighting system with respect to daylight, wherein the lighting system comprises an illumination device arranged in an illumination plane to illuminate a workspace plane.

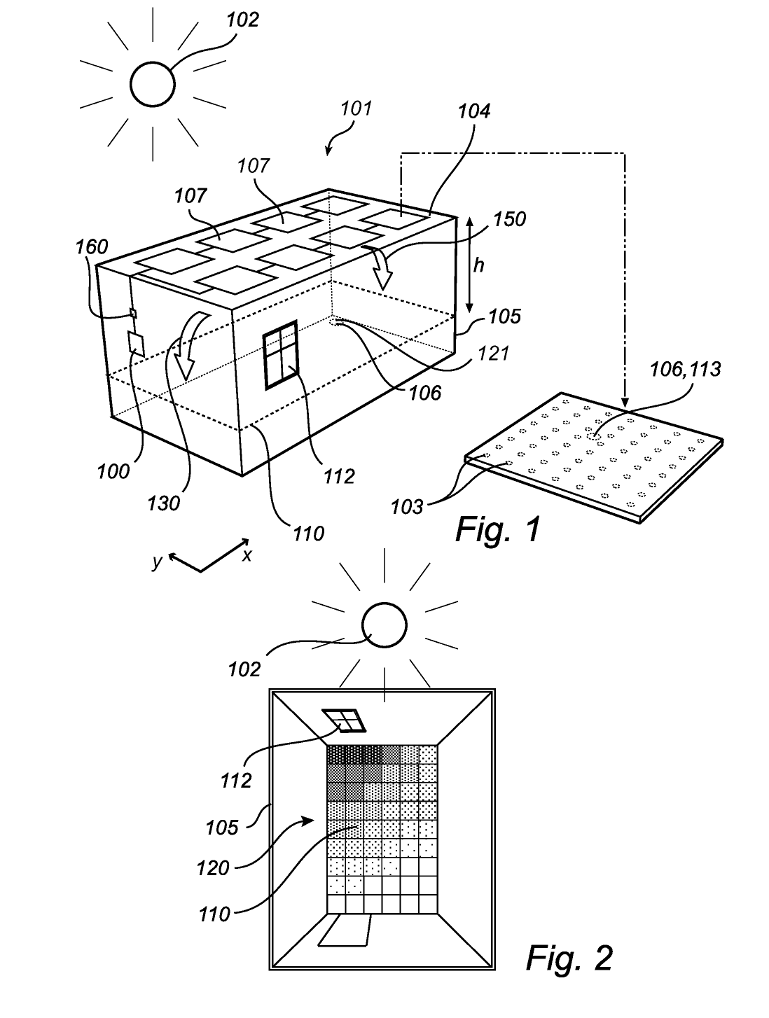

FIG. 1 is a schematic illustration of a configuration unit 100 for configuring a lighting system 101 with respect to daylight illumination 102. The lighting system 101 may comprise one or more illumination devices 103 arranged in an illumination plane 104. The illumination devices 103 may be light-emitting diodes (LEDs), which illumination devices 103 hereafter, for abbreviation reasons, are denoted LEDs 103. The LEDs 103 may be active (i.e. turned on), inactive (i.e. turned off), or dimmed by a factor d, where 0≦d≦1. The value d=0 means that the LED 103 is dimmed off, whereas d=1 represents a LED 103 at its maximum illumination. Hence, the average power consumed by a LED 103 at dimming level d is P(d)=d·Pₒ, where Pₒ is the power consumption when the LED 103 is on.

The LEDs 103 may be arranged in a symmetric grid in the illumination plane 104, or e.g. in a linear, rectangular, triangular or circular pattern. Alternatively, the LEDs may be arranged in any other irregular geometry. The illumination plane 104 may e.g. be the ceiling of a room 105. Alternatively, the illumination plane 104 may be a plane parallel to and arranged at a distance from the ceiling of the room 105, such that the LEDs 103 are comprised in another plane than the plane of the ceiling itself. Furthermore, one or more photosensors 106 may be provided in the illumination plane 104 for measuring light intensity. For example, there may be K LEDs 103 and N photosensors 106, whereas in a non-limiting specific example, the photosensors 106 may be coupled to the LEDs 103 in a one-to-one relation such that K=N. In the illumination plane 104 of the exemplifying embodiment shown in FIG. 1, there are eight light sources 107 in the illumination plane 104, each light source 107 comprising 56 LEDs 103 arranged in a 7×8 uniform square grid with a separation of approximately 0.1 m between the LEDs 103. Further, the spacing of the LEDs 103 may approximately be 0.9 m in one direction (e.g. along the length (y)), and 1.2 m in another direction (e.g. along the width (x)). The LEDs 103 may be of a type having a Lambertian radiation pattern with a half-power beam angle of 60° and a maximum intensity of 14.3 1×. It is assumed that the dimming level of the source 107 may be tunable at a group level, i.e. that LEDs 103 within a light source 107 may be at the same dimming level. An extension to the case wherein LEDs 103 in the light sources 107 are individually tunable is straightforward.

The illumination plane 104 may be arranged to illuminate a workspace plane 110, which may be substantially parallel to the illumination plane 104. The workspace plane 110 may e.g. be the floor of the room 105, or a plane above the floor. In FIG. 1, the illumination plane 104 and the workspace plane 110 are vertically separated with a distance h, and the workspace plane 110 in the room 105 may be construed as a plane wherein a target, such as e.g. a person, may move.

The configuration unit 100 may be adapted to obtain a first contribution, D (xₖ, yₖ, 0), of daylight illumination 102, wherein the daylight illumination 102 may come from the sun and/or any lighting outside the room 105 (i.e. external lighting). The daylight illumination 102 may enter the room 105 through a window 112, or the like. The first contribution of daylight illumination 102 may be obtained at a first location 113, (xₖ, yₖ), in the illumination plane 104, i.e. a location at which a photosensor 106 is arranged. The first contribution of daylight illumination 102 may be obtained based on a first signal representative of a total light intensity, E_{T} (xₖ, yₖ, 0), measured at the first location 113 (xₖ, yₖ) in the illumination plane (i.e. z=0). Hence, the total light intensity measured at the first location 113 is dependent on the first contribution of daylight illumination 102.

Furthermore, the configuration unit 100 may be adapted to obtain a second contribution, D (x, y, h), of daylight illumination 102 at a second location 121, (x, y), in the workspace plane 110. The second contribution of daylight illumination 102 may be obtained based on a second signal representative of the total light intensity, E_{T} (x, y, h), measured at the second location 121 (x, y) in the workspace plane (i.e. z=h). The total light intensity may be measured at the second location 121 by one or more photosensors 106 which may be (at least temporarily) arranged at one or more locations in the workspace plane 110 during a configuration session.

Furthermore, the configuration unit 100 may be adapted to determine a transfer function or mapping table 130 representative of the relationship between the first contribution and the second contribution of daylight illumination 102. It will be appreciated that the transfer function 130 may be construed as a mathematical function or table which may transfer, correlate, or “map”, the first contribution of daylight illumination 102 from the illumination plane 104 to a contribution of daylight illumination at points in the workspace plane 110. Mapping to intermediate points of the second locations 121 in the workspace plane 110 may be obtained through suitable extrapolation.

The configuration unit 100 may be further adapted to estimate any first potential contribution, Σ_{i=0 to n} dᵢEᵢ (xₖ, yₖ, 0), of illumination by the LEDs 103 in the first signal for obtaining the first contribution of daylight illumination 102 (Σ_{i=0 to n} dᵢEᵢ (xₖ, yₖ, 0) represents the sum of the contributions of each one of the LEDs at a location (xₖ, yₖ) in the illumination plane). Hence, the first contribution of daylight illumination 102 and the first potential contribution of illumination by the LEDs 103 are obtained by the photosensors 106 installed in the illumination plane 104 as disaggregated contributions. Analogously, the configuration unit 100 may be adapted to estimate any second potential contribution, Σ_{i=0 to n} dᵢEᵢ (x, y, h), of illumination by the LEDs 103 in the second signal from measurements by photosensors (at least temporarily) arranged in the workspace plane 110. From the second potential contribution, the second contribution of daylight illumination 102 may be obtained. Furthermore, the configuration unit 100 may be adapted to determine an additional transfer function 150 representative of the relationship between the estimated first potential contribution and the estimated second potential contribution. The additional transfer function or mapping table 150 may be construed in the same way as the previously described transfer function 130.

The configuration unit 100 may further comprise a repetition of the step of obtaining the first contribution of daylight illumination 102 for a plurality of first locations 113 in the illumination plane 104, and of the step of obtaining the second contribution of daylight illumination 102 for a plurality of second locations 121 in the workspace plane 110. The repetitions for obtaining contributions of daylight illumination 102 for the first and second locations 113, 121 may be performed throughout the illumination plane 104 and/or the workspace plane 110. For example, a repetition of obtaining the first contribution of the daylight illumination 102 may be performed for each of the photosensors 106 arranged in the illumination plane 104 and/or for combinations of photosensors or locations 121 of photosensors in the workspace plane 104. Analogously, a repetition of obtaining the second contribution of the daylight illumination 102 may be performed for each of the photosensors 106 arranged in the illumination plane and/or for combinations of photosensors or locations 121 of photosensors in the workspace plane 110. Moreover, the repetitions for obtaining the contributions of daylight illuminations may be performed for a plurality of time instants, as the first and the second contributions may be dependent on the daylight illumination 102 as a function of time. Analogously, in estimating any first and second potential contributions of the LEDs 103 in the first and second signals, a repetition for a plurality of first and second locations 113, 121 in the illumination and workspace planes 104, 110 may be performed in a similar manner.

The first contribution, D(xₖ, yₖ, 0), of daylight illumination 102 may be obtained by subtracting the estimated first potential contribution, Σ_{i=0 to n} dᵢEᵢ (xₖ, yₖ, 0), from the first signal, E_{T} (xₖ, yₖ, 0), as follows:

D(xₖ,yₖ,0)=E_{T}(xₖ,yₖ,0)−Σ_{i=0 to n}dᵢEᵢ(xₖ,yₖ,0) equation (1)

wherein dᵢ is the dimming for the i-th LED 103, and the second contribution, D(xₖ, yₖ, h), of daylight illumination 102 may be obtained by subtracting the estimated second potential contribution, Σ_{i=0 to n} dᵢEᵢ (x, y, h), from the second signal, E_{T} (x, y, h), as follows:

D(xₖ,yₖ,h)=E_{T}(x,y,h)−Σ_{i=0 to n} dᵢEᵢ(x,y,h) equation (2)

The configuration unit 100 may further comprise the step of estimating the first and the second potential contributions of the LEDs 103 based on frequency division multiplexing (FDM). In FDM, each LED 103, group of LEDs or light source 107 is assigned a distinct frequency. The illumination intensity of the LEDs 103 may be controlled using a pulse width modulation (PWM), wherein the duty cycle is the dimming level of the LEDs 103. As a result, the contribution to a signal representative of the total light intensity measured at a location in the illumination plane or the workspace plane by a LED or group of LEDs may be separately identified by frequency analysis.

In FIG. 1, a control unit 160 for controlling lighting in the lighting system 101 is provided for controlling the LEDs 103 based on the determined first contribution of daylight illumination 102 in the illumination plane 104 and the transfer function 130. The control unit 160 may either receive or itself obtain the transfer function 130 for controlling the lighting system 101. For example, if the first contribution of daylight illumination 102 in the illumination plane 104 is high, and the control unit 160 estimates, via the transfer function 130, that the contribution of daylight illumination 102 in the workspace plane 110 is also high, the control unit 160 may control the lighting accordingly by e.g. decreasing the lighting from the LEDs 103. Analogously, the control unit 160 may control the LEDs 103 based on any first potential contribution of illumination by the LEDs 103 in the obtained signal and the additional transfer function 150, which may either be received or obtained.

The control unit 160 may be adapted for controlling the LEDs 103 dependent on the daylight which may have a dynamically changing distribution. The control unit 160 may be provided with any control algorithm suitable for controlling the lighting in the lighting system 101.

In FIG. 2, a second contribution 120 of daylight illumination 102 in the workspace plane 110 is shown as a discrete distribution grid in a room 105 of e.g. length 4.5 m and width 3 m, wherein the workspace plane 110 is located about 2 m from the ceiling. The window 112 is located at the upper left hand side of the room 105 (as shown in FIG. 2). Close to the window 112, the second contribution 120 of daylight illumination 102 in the workspace plane 110 is high, whereas the second contribution 120 of daylight illumination 102 decreases gradually towards the lower, right hand side of the room, further away from the window 112.

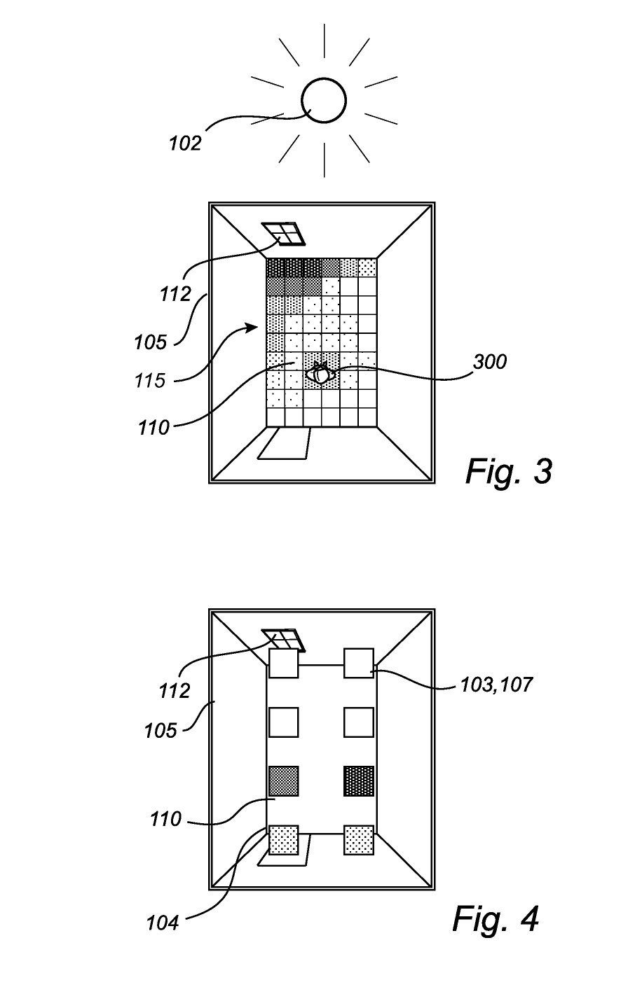

FIG. 3 is a diagram of a total light intensity 115 represented in the workspace plane 110 during control of the lighting system. The control unit 160 may receive information about the presence of a target 300 detected in the workspace plane 110 of the room 105 at the coordinate (e.g. x=0; y=2.25), wherein the information may be received from a detection sensor. For example, for each target 300 in the room 105, an occupied region Rₒ may be defined as the collection of all second locations 121 in the workspace plane 110. In the occupied region Rₒ, a uniform illumination at level Lₒ may be desired. In an unoccupied area, it may be desired to have a lower or minimal illumination level of Lᵤ, wherein the levels Lₒ and Lᵤ may be chosen based on illumination norms. In practice, uniform illumination requires that variations in the illumination level about the value Lₒ preferably are below a certain threshold, Cₒ, for energy efficiency reasons.

The control unit 160 may control the lighting in the lighting system 101 based on whether a target 300 is detected in the workspace plane 110, and more specifically, based on the position and/or the number of targets 300 detected in the workspace plane 110. In FIG. 3, the total light intensity 115 at the location of the target 300 is higher than at a location around the target 300. For this purpose, the control unit may control the LEDs arranged above the target 300 such that the illumination level at the target 300 reaches Lₒ in case daylight illumination is not sufficient for reaching Lₒ. Close to the window 112, the total light intensity 115 is high due to the second contribution 120 of daylight illumination 102 entering through the window 112.

FIG. 4 is a diagram of eight light sources 107 arranged in the illumination plane 104 in the room 105. The light sources 107 comprise LEDs 103 which have been dimmed (or have not been dimmed) based on the detected target 300 in FIG. 3 and based on the first contribution of daylight illumination 102 in the illumination plane 104. LEDs 103 in the illumination plane 104 close to the location of the target 300 in the workspace plane 110 are not dimmed, or just slightly dimmed, to provide a suitable illumination for the target 300. On the other hand, in the upper portion of the room 105, the LEDs 103 are strongly dimmed, or completely dimmed, i.e. turned off. This is an effect of the portion of the room 105 being close to the window 112 and at a distance far away from the target 300, thereby not requiring as much illumination in the workspace plane 110.

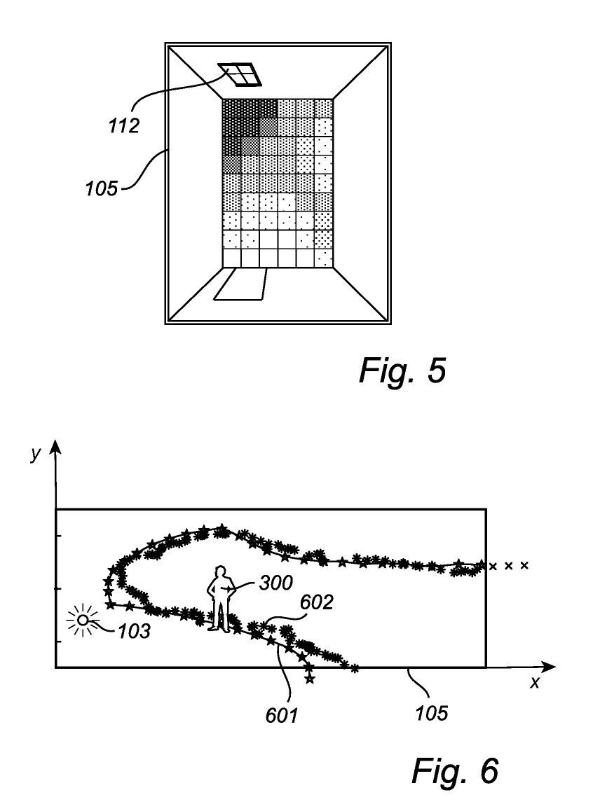

FIG. 5 is a diagram of energy savings for different locations of target(s) 300 in the room 105. The energy savings are greater at locations of target(s) 300 close to the window 112, and more specifically, at locations where the second contribution of daylight illumination 102 is high. This means that the contribution required from the LEDs 103 to meet illumination requirements at such locations is minimal, leading to an improved energy efficiency.

FIG. 6 is a view of a trajectory 601, e.g. a path, a route or a way, of a target 300 in a room 105, wherein the trajectory 601 of the target 300 is estimated as a function of time. Hence, it is here meant that the target 300, estimated at e.g. the location x₁, y₁ at time t₁, is estimated to be at e.g. x₂, y₂ at time t₂, and further at e.g. x₃, y₃ at time t₃, etc.

As shown by the trajectory 601 marked by a number of stars, the target 300, depicted as a person, enters the room 105 from approximately the middle of the long side of the room 105, and then turns left and walks to the left side of the room 105 towards the short end of the room 105. From there, the target 300 turns right and walks along the long side of the room 105 opposite the long side from which the person entered the room 105. The target 300 then exits the room 105 at the right side of the room 105.

The trajectory 601 of the target 300 may be estimated by the control unit 160, or alternatively, be estimated by a separate entity. The control unit 160 may further control the lighting in the lighting system 101 based on an estimated trajectory 602 of the real trajectory 601 of the target 300. The result of such an experiment is shown in FIG. 6, wherein the estimated trajectory 602, shown as a number of asterisks, closely follows the real trajectory 601 of the target 300 in the room 105.

The LEDs 103 may be controlled such that if the target 300 is estimated to be present at e.g. x₁, y₁ at time t₁ and at e.g. x₂, y₂ at time t₂, wherein the positions are comprised in the estimated trajectory of the target, LEDs 103 may be illuminated at time t₁, or at a time close to t₁, to light up an area at the coordinates x₁, y₁, and that LEDs 103 may be illuminated at time t₂, or at a time close to t₂, to light up an area at the coordinates x₂, y₂, etc. Analogously, the lighting of the respective LEDs 103 may be dimmed when the target 300 is relatively distant from the estimated locations x₁, y₁ at time t₁ and at e.g. x₂, y₂ at time t₂. For example, when the target 300 enters the room 105, one or more of the LEDs 103 may be illuminated, whereas one or more of the LEDs may be dimmed when the target 300 leaves the room 105.

Even though the invention has been described with reference to specific exemplifying embodiments thereof, many different alterations, modifications and the like will become apparent for those skilled in the art. The described embodiments are therefore not intended to limit the scope of the invention, as defined by the appended claims.

It will be appreciated that the environment of the invention may be different from that shown in FIG. 1. For example, the invention may be provided in an outdoor application instead of in a room. Furthermore, any sizes and/or number of units, devices or the like may be different than those described. For example, the configuration and/or number of light sources 107 may be provided in any other way than that shown in FIG. 1. It will also be appreciated that, although the configuration session by the configuration unit of the lighting system and in accordance with the method of the present invention may be advantageously performed at installation of the lighting system, the configuration session may be performed at any time, even after installation of the lighting system. Thus, the configuration unit may be configured to perform a configuration session of the lighting system at predetermined time intervals in order to provide an updated configuration. Such an implementation is advantageous since the environment in e.g. a room in terms of light conditions such as shadows, light reflections, etc., might have changed since the installation, e.g. due to furniture displacements in the room 105.

1. A method of configuring a lighting system with respect to light other than light emitted from at least one illumination device, wherein the lighting system comprises the at least one illumination device arranged in an illumination plane to illuminate a workspace plane, the method comprising the steps of:
obtaining a first contribution of the light other than light emitted from the at least one illumination device at a plurality of first location in the illumination plane based on a first signal representative of a total light intensity measured at each first location;
obtaining a second contribution of the light other than light emitted from the at least one illumination device at a plurality of second location in the workspace plane based on a second signal representative of a total light intensity measured at each second location; and
determining a transfer function which maps at points in the workspace plane the first and the second contributions of the light other than light emitted from the at least one illumination device.

2. A method as claimed in claim 1, wherein the at least one illumination device is turned off.

3. A method as claimed in claim 1, further comprising the steps of:
estimating any first potential contribution of illumination by the at least, one illumination device in the first signal for obtaining the first contribution of the light other than light emitted from the at least one illumination device; and
estimating any second potential contribution of illumination by the at least one illumination device in the second signal for obtaining the second contribution of the light other than light emitted from the at least one illumination device.

4. A method as claimed in claim 3, further comprising the step of:
determining a transfer function representative of the relationship between the estimated first potential contribution and the estimated second potential contribution.

5. A method as claimed in claim 4, wherein the step of obtaining a first contribution of the light other than light emitted from the at least one illumination device is repeated for plurality of time points, and the step of obtaining a second contribution of the light other than light emitted from the at least one illumination device is repeated for a plurality of time points.

6. A method as claimed in claim 4, wherein the step of estimating any first potential contribution is repeated for a plurality of first locations in the illumination plane or a plurality of power levels, and the step of estimating any second potential contribution is repeated for a plurality of second locations in the workspace plane or a plurality of power levels.

7. A method as claimed in claim 4, wherein the first contribution of the light other than light emitted from the at least one illumination device is obtained by subtracting the estimated first potential contribution from the first signal, and wherein the second contribution of the light other than light emitted from the at least one illumination device is obtained by subtracting the estimated second potential contribution from the second signal.

8. A method as claimed in claim 4, wherein the step of estimating the first potential contribution and the second potential contribution is based on frequency division multiplexing.

9. A method of controlling lighting in a lighting system comprising at least one illumination device arranged in an illumination plane to illuminate a workspace plane, the method comprising the steps of:
receiving a transfer function which maps at points in the workspace plane the contribution of light other than light emitted from the at least one illumination device in the illumination plane and the contribution of the light other than light emitted from the at least one illumination device in the workspace plane;
obtaining a signal representative of a total light intensity measured at a location in the illumination plane;
determining the contribution of the light other than light emitted from the at least one illumination device in the obtained signal; and
receiving information relating to presence detection of a target in the workspace plane;
controlling the at least one illumination device based on the determined contribution, in the illumination plane, of the light other than light emitted from the at least one illumination device and the transfer function, and on the position of the target in the workspace plane.

10. A method as claimed in claim 9, further comprising the step of estimating any potential contribution of illumination by the at least one illumination device in the obtained signal, wherein the contribution of the light other than light emitted from the at least one illumination device is based on the estimated potential contribution.

11. A method as claimed in claim 9, further comprising the step of:
receiving an additional transfer function representative of the relationship between the contribution of illumination by the at least one illumination device at a location in the illumination plane and the contribution of illumination by the at least one illumination device at a location in the workspace plane;
wherein the controlling of the at least one illumination device is further based on the additional transfer function.

12. (canceled)

13. A method as claimed in claim 9, wherein the step of controlling the illumination device is further based on a predetermined illumination level or predetermined range of illumination levels in the workspace plane.

14. A configuration unit for configuring a lighting system with respect to light other than light emitted from at least one illumination device, the lighting system comprising the at least one illumination device arranged in an illumination plane to illuminate a workspace plane, the configuration unit being adapted to:
obtain a first contribution of the light other than light emitted from the at least one illumination device at a first location in the illumination plane based on a first signal representative of a total light intensity measured at the first location;
obtain a second contribution of the light other than light emitted from the at least one illumination device at a second location in the workspace plane based on a second signal representative of a total light intensity measured at the second location; and
determine a transfer function representative of the relationship between the first and the second contributions of the light other than light emitted from the at least one illumination device.

15. A control unit for controlling lighting in a lighting system comprising at least one illumination device arranged in an illumination plane to illuminate a workspace plane, the control unit being adapted to:
receive a transfer function which maps at points in the workspace plane the contribution of light other than light emitted from the at least one illumination device in the illumination plane and the contribution of the light other than light emitted from the at least one illumination device in the workspace plane;
obtain a signal representative of a total light intensity measured at a location in the illumination plane;
determine the contribution of the light other than light emitted from the at least one illumination device in the obtained signal;
Receive information relating to presence detection of a target in the workspace plane; and
control the at least one illumination device based on the determined contribution, in the illumination plane, of the light other than light emitted from the at least one illumination device and the transfer function, and on the position of the target in the workspace plane.
